(19) United States
(12) Patent Application Publication
(10) Pub. No.: US 2006/0195361 A1
(43) Pub. Date: Aug. 31, 2006

(54) LOCATION-BASED DEMOGRAPHIC PROFILING SYSTEM AND METHOD OF USE

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, Pismo Beach, CA (US)

(21) Appl. No.: 11/383,197

(22) Filed: May 12, 2006

Related U.S. Application Data
(60) Provisional application No. 60/723,021, filed on Oct. 1, 2005.

(51) Int. Cl. G06Q 30/00

(52) U.S. Cl. 705/14

(57) ABSTRACT

A location-based demographic profiling system and method is disclosed that enables users to access information about physical establishments indicating the demographic makeup of the patrons currently located within the establishment. In one embodiment, a location-based demographic profiling method is employed that includes receiving, over a network, a profile request from a user device, the profile request identifying at least one establishment from a plurality of pre-identified establishments; upon receiving the profile request, determining a current demographic profile of each establishment identified in the profile request, wherein each current demographic profile is a statistical representation of the number of individuals residing with an identified establishment who possess at least one identified demographic characteristic; and transmitting demographic profile data to the user device, the demographic profile data being adapted to cause the user device to present the determined demographic profile to be presented to the user.

This application claims the benefit of U.S. Provisional Application No. 60/723,021, filed Oct. 1, 2005, which is incorporated in its entirety herein by reference.

### BACKGROUND

1. Field of Invention

Embodiments exemplarily described herein relate generally to the field of storing and accessing information based upon physical geographic locations. More specifically, embodiments exemplarily described herein relate to the field of mobile social networking applications. Even more specifically, embodiments exemplarily described herein relate to methods and systems for collecting information regarding demographic characteristics, computing a demographic profile of a population of individuals residing within an establishment pertaining, and allowing a user to selectively accessing the demographic profile of a particular establishment (whether or not the user is located at or near that establishment). As used herein, the demographic profile describes, represents and/or estimates the number and/or percentage of individuals within an establishment that possess one or more particular demographic characteristics.

2. Discussion of the Related Art

A number of systems have been developed for accessing location-related information. For example, a paper by Spohrer entitled Information in Places and published in IBM Systems Journal, vol. 38, No. 4, 1999 (p. 602-628) which is hereby incorporated by reference, describes a system in which information is stored and accessed based upon physical geographic locations. In most such systems, the location-related information is accessed by a user of a portable computing system based upon the then current location of the portable computing system as determined by one or more Global Positioning System (GPS) sensors local to the portable computing system. For example, U.S. Pat. No. 6,122,520, entitled System and Method for Obtaining and Using Location Specific Information and hereby incorporated by reference, can be understood to describe a system that uses Navstar Global Positioning System (GPS) in combination with a distributed network to access location-related information based upon GPS coordinates that describe the current location of a mobile computing device. In addition, U.S. Pat. No. 6,819,267, entitled System and Method for Proximity Bookmarks Using GPS and Pervasive Computing and hereby incorporated by reference, can be understood to describe a system for accessing location-related information using GPS coordinates that indicate the current location of a mobile computing device. U.S. Patent Application Publication No. 2005/0032528, entitled Geographical Web Browser, Methods, Apparatus and Systems and hereby incorporated by reference, can be understood to describe a system for accessing location-related information using GPS coordinates that indicate the current location of a mobile computing device.

As known to the inventor of the present application, however, a user may want to gain information about the people who are currently located at a particular location and because such information varies continuously, such information cannot be statically associated with the location. Therefore, it would be beneficial if a dynamic and efficient means existed for tracking the current demographic makeup of the people who are located in an establishment and linking that information to the establishment in a way that can be accessible by other users who are interested in knowing the current demographic makeup of the patrons to that establishment.

Another technology known to the current art that is related to the present invention is referred to herein as mobile social networking systems. Such applications are generally operated as managed services by application service providers (ASPs) and operate using several common characteristics. For example, users typically create unique personal profiles that include basic information including age, gender, user name, interests, profession, history, testimonials and information about their network. In some applications, users map their relationship with other members in a relationship map, either by inviting other members to join their network (e.g., Friendster and/or Linkedin), or by using software to scan existing relationships recorded in computer contact software (e.g., Spoke and/or Visible Path). Most commonly, these applications provide such functions as friend-finding, text-dating and community message aggregation. Friend-finder applications (e.g., Dodgeball) can identify the location of a user and the friend of the user and alert the user when the friend is within a certain proximity. Such applications may also consult the relationship map and identify “friends of friends” who have announced they are within a certain range of the user's vicinity. Text-dating applications (e.g., MobiVibe) allow users to connect with new friends who meet age and gender criteria, enabling users to communicate, e.g., to exchange text messages. Community message aggregators (e.g., Upoc) distribute messages from one member to all members within a specific community. A system disclosed in U.S. Patent Application Publication No. 2005/0177614, which is hereby incorporated by reference, can be understood to enable like-minded mobile device users to meet one another on a permission basis based upon one or more factors such as: each user's reciprocal networking objective, the nature of the industry in which the user works, the user's level within the management hierarchy of his or her company, any specialty function the individual may possess, and so on.

As known to the inventor of the present application, however, current mobile social networking systems such as those mentioned above do not allow a user to access statistical information about the demographic makeup of people who are currently located at a particular establishment. This is often highly desirable information for a user who is trying to decide whether or not to go to a particular establishment in search of social encounters with people of particular personal characteristics. For example, a person considering going to a particular bar in hope of meeting people of a particular age and gender and who are fans of a particular sporting team may with to review in advance the statistical makeup of the currently present patrons within that particular bar by age, gender, and sporting teams preferences. Similarly, a person considering going to a particular dance club in hope of meeting people of a particular gender, marital status, and political affiliation, may wish to review in advance the statistical makeup of the currently present patron population in that dance club by gender, marital status, and political affiliation. Therefore, it would be beneficial if a dynamic and efficient means existed for enabling information describing the current demographic makeup of patrons who are located in an establishment to be accessed by other users who are interested in knowing the current demographic makeup of the patrons to that establishment.

### SUMMARY

Several embodiments exemplarily described herein address the needs above as well as other needs by providing a location-based demographic profiling system and associated uses.

One embodiment exemplarily described herein provides a location-based demographic profiling method that includes receiving, over a network, a profile request from a user device; determining a current demographic profile of each establishment identified in the profile request upon receiving the profile request; and transmitting demographic profile data to the user device. The profile request identifies at least one establishment from a plurality of pre-identified establishments. Each current demographic profile is a statistical representation of the number of individuals residing within an identified establishment who possess at least one identified demographic characteristic. The demographic profile data is adapted to cause the user device to present each determined demographic profile to be presented to the user.

Another embodiment exemplarily described herein provides a location-based demographic profiling system that includes a server containing server demographic profiling (DP) circuitry adapted to: receive, over a network, a profile request from a user device; determine a current demographic profile of each establishment identified in the profile request upon receiving the profile request; and transmit demographic profile data to the user device. The profile request identifies at least one establishment from a plurality of pre-identified establishments. Each current demographic profile is a statistical representation of the number of individuals residing within an identified establishment who possess at least one identified demographic characteristic. The demographic profile data is adapted to cause the user device to present the determined demographic profile to be presented to the user.

Yet another embodiment exemplarily described herein provides a location-based demographic profiling method that includes steps of providing a DP Server operative to maintain demographic profile information for each of a plurality of physical establishments, the demographic profile information representing the number of individuals known to be currently residing within the establishment who possess each of a plurality of different demographic characteristics; enabling profile requests to be made to the DP Server by each of plurality of distant users of separate computing devices, each of the profile requests being communicated from each separate computing device to the DP server and indicating at least one physical establishment to be profiled; transmitting demographic profile information to each of the separate computing devices in response to each of the profile requests, the demographic profile information including statistical data indicating the number of individuals possessing each of a plurality of different demographic characteristics who are known to be currently residing within the at least one physical establishment identified by the profile request received from that particular separate computing device; and enabling the display of the demographic profile information to the user of each of the separate computing devices, the display being at least one of a graphical representation of the demographic profile information that was transmitted to that separate computing device in response to a profile request received from that separate computing device and an aural representation of the demographic profile information that was transmitted to that separate computing device in response to a profile request received from that separate computing device.

### BRIEF DESCRIPTION OF THE DRAWINGS

The above and other aspects, features and advantages of several embodiments exemplarily described herein will be more apparent from the following more particular description thereof, presented in conjunction with the following drawings.

FIG. 1 illustrates one embodiment of a schematic representation of an exemplary location-based demographic profiling service;

FIG. 2 illustrates one embodiment of an exemplary mobile computing device; and

FIG. 3 illustrates a sample display as would be shown upon the mobile computing device shown in FIG. 2.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

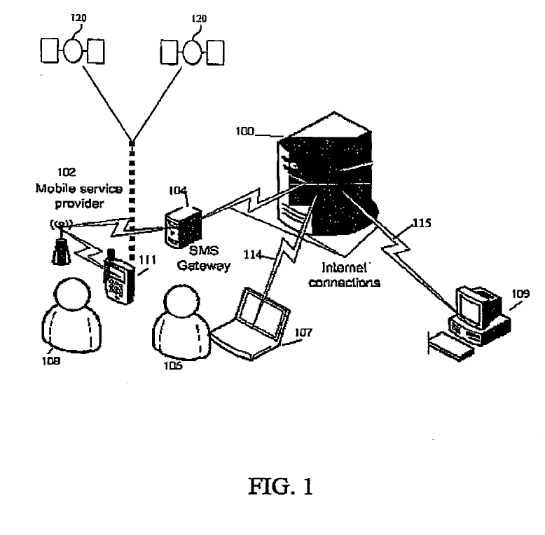

In one embodiment exemplarily illustrated in FIG. 1, a location-based demographic profiling system may, for example, include a server or a group of servers (generically referred to herein as a “DP server 100”) supporting server DP circuitry, one or more establishment computers 109 supporting client DP circuitry, and one or more user devices (e.g., 107 and 111) also supporting client DP circuitry. As used herein, the term “circuitry” refers to any type of executable instructions that can be implemented, for example, as hardware, firmware, and/or software, which are all within the scope of the various teachings described.

As illustrated, the DP server 100 is a single machine. However, one of ordinary skill will appreciate that this is not a limitation of the invention. In one embodiment, the DP server 100 is connected or is connectable to one or more networks. The DP server 100 may be accessed by a plurality of users over a communication link, each of whom may selectively receive current demographic profile about one or more location-based establishments tracked by the DP server 100.

In one general embodiment, each establishment computer 109 may be maintained local to respective location-based establishments. As used herein, a “location-based establishment” (or simply an “establishment”) refers to a physically definable physical location where people selectively visit such as a restaurant, bar, park, dance club, fitness club, party location, sporting field, store, mall, beach, swimming pool, billiards parlor, recreational center, senior center, library, lounge, and the like. An establishment computer 109 may be connected to other components not shown in FIG. 1 such as card readers, RFID scanners, and/or wireless communication links used to detect the entry and/or exit and or presence of patrons (also referred to herein as “individuals”) at or within the establishment.

In one general embodiment, a user device may be provided as personal computer or a mobile computing device (e.g., a personal computer 107, cell phone 111, PDA, portable media player, a processor-enabled wristwatch, or the like). As used herein, the term “mobile computing device” includes any mobile wireless client device, e.g., a cell phone, pager, a personal digital assistant (PDA, e.g., with GPRS NIC), a mobile computer with a smartphone client, or the like. A typical mobile computing device may include a wireless access protocol (WAP)-enabled device that is capable of sending and receiving data in a wireless manner using the wireless application protocol. WAP allows users to access information via wireless devices, such as mobile phones, pagers, two-way radios, communicators, and the like. WAP supports wireless networks, including CDPD, CDMA, GSM, PDC, PHS, TDMA, FLEX, ReFLEX, iDEN, TETRA, DECT, DataTAC, and Mobitex, and it operates with many handheld device operating systems, such as PalmOS, EPOC, Windows CE, FLEXOS, OS/9, and JavaOS. Typically, WAP-enabled devices use graphical displays and can access the Internet (or other communication network) on so-called mini- or micro-browsers, which are web browsers with small file sizes that can accommodate the reduced memory constraints of handheld devices and the low-bandwidth constraints of a wireless networks. In a representative embodiment, the mobile device is a cellular telephone that operates over GPRS (General Packet Radio Service), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. In an illustrated embodiment, mobile device users use SMS, which is a text message service that enables short messages (e.g., generally no more than 140-160 characters in length) to be sent and transmitted from a mobile computing device. Embodiments described herein are not limited to mobile device users who have WAP-enabled devices or to use of any particular type of wireless network. Such devices and networks are merely illustrative; any wireless data communication technology now known or hereafter developed may be used in conjunction with the embodiments described herein.

In one embodiment, mobile computing devices suitable to be implemented in conjunction with the embodiments exemplarily described herein have access to locative data such as GPS data used for determining a current spatial location (i.e., tracking) of the mobile computing device. GPS data is generally derived by a transceiver on board the mobile computing device that references orbiting satellites 120 associated with a Global Positioning System (GPS).

Global Positioning System (GPS) technology provides latitudinal and longitudinal information on the surface of the earth to an accuracy of approximately 100 feet. When combined with accurate location references and error correcting techniques, such as differential GPS, an accuracy of better than 3 feet may be achieved. This information may be obtained using a positioning system receiver and transmitter, as is well known in the art. For purposes of this application, the civilian service provided by Navstar Global Positioning System (GPS) will be discussed with reference to the invention. However, other positioning systems are also contemplated for use with the present invention. For GPS to provide location identification information (e.g., a coordinate), the GPS system comprises several satellites each having a clock synchronized with respect to each other. The ground stations communicate with GPS satellites and ensure that the clocks remain synchronized. The ground stations also track the GPS satellites and transmit information so that each satellite knows its position at any given time. The GPS satellites broadcast “time stamped” signals containing the satellites' positions to any GPS receiver that is within the communication path and is tuned to the frequency of the GPS signal. The GPS receiver also includes a time clock. The GPS receiver then compares its time to the synchronized times and the location of the GPS satellites. This comparison is then used in determining an accurate coordinate entry.

In one general embodiment, the server DP circuitry is adapted to track a current demographic profile of patrons within one or more location-based establishments (i.e., a statistical and/or numerical measure of the human population present within the establishment quantified with respect to one or more personal demographic characteristics). It will be appreciated that there will generally be some time lag that causes the most current demographic profile to not account for people who may have very recently entered or exited an establishment within, for example, the last few seconds to the last few minutes. Nevertheless, it is generally desirable to keep such time lags as small as possible within the practical limitations of the technology employed. In this sense, a current demographic profile is a demographic profile that represents the demographic characteristics of the population of individuals residing within an establishment as close to “real time” as possible.

In one general embodiment, the server DP circuitry is adapted to store a time-history of past demographic profiles for each of a plurality of establishments, the time-history of an establishment reflecting one or more current demographic profiles of that establishment at previous points in time. In a further embodiment, the server DP circuitry may be adapted to predict a future demographic profile of an establishment based at least in part upon the stored time-history of past demographic profiles for that establishment at similar days of the week and/or times of day. In a further embodiment, the server DP circuitry may be adapted to predict a future demographic profile for an establishment based upon a current rate-of-change of users at or within the establishment having one or more personal characteristic. For example, if the percentage of women within an establishment is increasing at a particular rate at a given point in time, that rate of change (i.e. the influx rate of women) may be used to predict a future demographic profile for the establishment by some embodiments.

In one general embodiment, the server DP circuitry may be adapted to maintain and access a personal profile database (not shown) containing personal profile information, for each of a plurality of users. As used herein, the phrase “personal profile information” includes, but is not limited to, predetermined demographic characteristics of the user such as age, gender, highest level of schooling, marital status, political party affiliations, school affiliations, team affiliations, club affiliations, organizational affiliations, hobbies, interests, profession, job title and/or hierarchy level within an organization, sexual orientation, annual income, sporting team preferences, status as a tourist or resident of the current geographic region, relationship status (i.e. whether in a relationship or looking for a relationship), musical preferences, IQ, entertainment preferences, food preferences, and/or other similar characteristics. In one embodiment, the DP server circuitry is adapted to access the personal profile database locally and/or remotely. In a further embodiment, the DP server circuitry is adapted to maintain the personal profile database by indexing personal profile information contained therein according to a user identifier (ID) (e.g., an account number, or other identifier) uniquely associated with that user's personal profile information. In one embodiment, users may create new entries and/or update existing entries within the personal profile database by, for example, accessing the DP server 100 via a user device and engaging in a registration and/or update process.

In one general embodiment, the server DP circuitry may be adapted to access the personal profile information for each of the plurality of users using the user ID. In a further embodiment, the server DP circuitry may be adapted to receive a user ID associated with that user, reference the received used ID with the user ID indexed within the personal profile database, and access personal profile information associated with the referenced user ID. This allows for reduced information exchange with the DP server 100 and eliminates the need to exchange the actual personal profile information for each user. Instead, only the unique identifier for each user needs to be exchanged. Exchanging only the unique identifier for each user also helps to protect the private information of individuals such that their personal demographic characteristics need not be often communicated to the DP server 100. In a further embodiment, the unique identifier may be specific to the DP server 100 and not identify an individual by name, social security number, or other widely known personal identifier. In this way, a user may maintain a personal profile the DP server 100 with substantial personal information but still remain substantially anonymous.

In one general embodiment, the server DP circuitry is adapted to allow a plurality of users (e.g., 106 and 108) to access the most current demographic profile of one or more of the plurality of location-based establishments via user devices associated with each of the plurality of users.

In one general embodiment, the server DP circuitry is adapted to receive information about users entering, exiting, and/or residing within location-based establishments. Such information may be communicated by client DP circuitry supported by an establishment computer 109 and/or client DP circuitry supported by a user device.

In one general embodiment, the server DP circuitry is adapted to receive requests for a current demographic profile for particular location-based establishments, respond to the requests by computing demographic profiling information, and report the computed demographic profiling information. Such requests may be communicated by client DP circuitry supported by a user device. Such reports may be communicated from the DP server 100 to the to the requesting user device.

In one general embodiment, the client DP circuitry is adapted to communicate personal profile information and/or the user ID of the user with the DP server 100. For example, client DP circuitry supported by user device 111 (e.g., a cell phone) may communicate with the DP server 100 via mobile service provider (MSP) 102 through a gateway (e.g., SMS gateway 104), client DP circuitry supported by user device 107 (e.g., a personal computer) may communicate with the DP server 100 via communication link 114, and client DP circuitry supported by an establishment computer 109 may communicate with the DP server 100 via communication link 115. In a further embodiment, the client DP circuitry is adapted to communicate the user ID of the user with the DP server 100.

In one general embodiment, client DP circuitry supported by a user device (e.g., a personal computer, a mobile computing device, etc.) is adapted to enable users to select and/or enter location-based establishments for which current demographic information is desired. In one embodiment, such client DP circuitry is adapted to enable users to select and/or enter which demographic characteristics and/or which combinations of demographic characteristics for which profile information is desired. Such a selection is sent to the DP server 100 upon the user performing an inquiry process. Upon receiving the resulting current demographic profile from the DP server 100, client DP circuitry supported by the selecting user device is adapted to cause the current demographic profile to be displayed to the user in visual and/or aural form. In this way, users can selectively access and view a current demographic profile about location-based establishment.

In one general embodiment, client DP circuitry supported by an establishment computer 109 is adapted to communicate the personal profile information and/or the user ID for each user that enters, exits, and/or resides within an establishment.

The location-based demographic tracking system exemplarily illustrated in FIG. 1 may be implemented as a managed service (e.g., in an ASP model) via the DP server 100. More generally, the service is provided by an operator using a set of one or more computing-related entities (e.g., systems, machines, processes, programs, libraries, functions, or the like, or combinations thereof) that together facilitate or provide the inventive functionality described herein. In a typical implementation, the service comprises a set of one or more computers. A representative machine is a network-based server running commodity (e.g. Pentium-class) hardware, an operating system (e.g., Linux, Windows, OS-X, or the like), an application runtime environment (e.g., Java, ASP) and a set of applications or processes (e.g., Java applets or servlets, linkable libraries, native code, or the like, depending on platform), that provide the functionality of a given system or subsystem. The service may be implemented in a standalone server, or across a distributed set of machines. Typically, a server connects to the publicly-accessible Internet, a corporate intranet, a private network, or any combination thereof, depending on the desired implementation environment.

In one embodiment, one or more users (e.g., 106 and/or 108) register for the service, typically by using a user device (e.g., 107 or 111). When personal computer 107 is used, registration is initiated by user 106 opening a Web browser to the operator's Web site registration page (or set of registration pages). When a mobile computing device 111 is used, registration may be initiating through a mini-browser or other similar interface. These techniques are merely representative, as any convenient technique (including, without limitation, email, filling out and mailing forms, and the like) may be used. Thus, in the illustrated embodiment, users register with the DP server 100 either through Internet connections from personal computers, or via remote registration through a mobile device.

In one embodiment, a user may enter their personal profile information through a user interface of a user device upon registering for the service. In addition, users can update their personal profile information as stored within the personal profile database from time to time as their demographic characteristics change. For example, if a user gets married he or she may update his or her personal profile information related to marital status. In addition, the personal profile information may include the user's birth date such that his or her age can be automatically updated by the software that maintains the personal profile database and/or the server DP circuitry as his or her age changes over time.

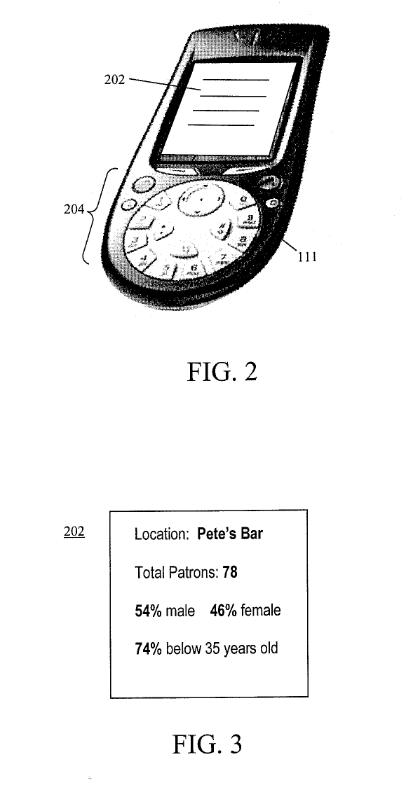

FIG. 2 exemplarily illustrates the mobile computing device 111 shown in FIG. 1. As shown, the mobile computing device 111 may be implemented as a handheld device such as a cell phone or PDA and include a user interface comprising a display 202 and interface controls 204. Because the mobile computing device 111 contains client DP circuitry, information may be communicated between the mobile computing device 111 and the DP server 100 over a communication link. The communication link may take any common form (e.g., a wireless communication link to an information network such as the Internet). The mobile computing device 111 may also include a differential GPS transceiver (not shown) or other locative sensor for sensing the geographic location of the mobile computing device with a high degree of accuracy. In one embodiment, the display 202 includes a graphical user interface that allows users to enter information and/or make selections to configure and/or otherwise control operations of the client DP circuitry. For example, the graphical user interface may include menus and/or forms through which a user can select a particular location-based establishment or establishments for which a current demographic profile is desired. In addition, the graphical user interface may include menus and/or forms through which a user can select particular demographic characteristics that should be included in the current demographic profile of the selected location-based establishment. Demographic characteristics may be selected independently or in combination. In addition, the graphical user interface of the mobile computing device 111 is also used, under the control of client DP circuitry, to present to the user the current demographic profile of a particular location-based establishment. For example, the user may request a current demographic profile of a particular establishment (e.g., “Pete's Bar”) and may specify that such information is desired with respect to gender and age less than 35 years old, those characteristics being treated independently. As shown in FIG. 3, the display 202 may include a graphical display of the resulting current demographic profile received from the DP server 100 regarding the specified establishment and demographic characteristics. As shown, the display 202 graphically indicates that 78 patrons currently reside within Pete's Bar and that 54% of them are male and 46% are female. The display 202 also graphically indicates that 74% of the patrons within Pete's bar at the current time are of an age that is less than 35 years old. In this way, the mobile computing device 111 allows a user to request and view current demographic profiling information about a physical establishment through interactions with the DP server 100. The specific interactions with the DP server 100 will be described in greater detail below.

Having generally described the various components of the demographic tracking system above, an exemplary method by which a user may access the current demographic profile of one or more establishments will now be described.

A user (e.g., 106 or 108) may access current demographic profile via his or her user device (e.g., 107 or 111). For example, a user, through his or her user device, may establish a communication connection with the DP server 100 and identify through data exchanged with the DP server 100 which establishment(s) of a plurality of establishments tracked by the DP server 100 the user desires current demographic profile for. In one example, a user device may be a network-enabled cell phone. By interacting with the user interface of the cell phone, the user may select a particular dance club establishment. This may be achieved by selecting the dance club from a list of available establishments, by typing in the name or identifier of the dance club, or by searching a database by location. The may alternately select the establishment by interacting with a graphical geospatial mapping application such as Google Earth or Microsoft Virtual Earth. If the cell phone is equipped with GPS tracking capabilities the selection process may include the display of all clubs within a particular distance from the user's current geographic location, the user selecting the particular dance club to be referenced. Regardless of the user interface method, the user selects a particular dance club by engaging the user interface of the cell phone. The user may also identify which demographic characteristics he or she is interested in including within a generated current demographic profile. This too may be achieved by making selections and/or entering choices into the user interface of the cell phone. In some embodiments, the user may require a default set of demographic characteristics. In this particular example, the user manually selects age, gender, and marital status as the three demographic characteristics he or she desires information about. In response to the user input, client DP circuitry supported by the cell phone sends a profile request message (also referred to as a profile request) to the DP server 100, the profile request message indicating the particular dance club that the user desired current demographic profile for as well as indicating the three specified demographic characteristics that profile information is desired for. In this sense, the profile request message identifies at least one establishment from a plurality of pre-identified establishments.

In response to the profile request message from the user device (e.g., the aforementioned cell phone), the DP server 100 accesses information associated with each of the designated establishments stored within the personal profile database, computes the requested demographic profile, and provides the desired current demographic profile to the user by sending demographic profile data from the server to the computing device of the user. Continuing with the example in the preceding paragraph, the DP server 100 accesses the most current information indicating the age, gender, and marital status of participants within the identified dance club establishment. The DP server 100 then communicates this information back to the requesting cell phone. In many embodiments, the DP server 100 also communicates the total number of patrons currently within the given establishment for that piece of data is often desired by the requesting party.

Upon receiving the demographic profile data from the DP server 100, client DP circuitry supported by the user device (e.g., the aforementioned cell phone) presents a representation of demographic profile data for the designated establishments to the user (e.g., upon a user interface of the user device). The representation may be presented to the user in graphical and/or aural form to the user.

The demographic profile data may be graphically presented (i.e., displayed) as percentages of users who posses certain demographic characteristics or certain combinations of demographic characteristics who are currently at or within the specified establishment(s). The demographic profile data may be displayed as numerical totals of users who posses certain demographic characteristics or certain combinations of demographic characteristics who are currently at or within the specified establishment(s). The demographic profile data may be displayed as a combination of percentages and numerical totals. The demographic profile data may be displayed as alternate statistical measures. The displayed demographic profile data may also include an indication of the total number of patrons present within the specified establishment(s). To the extent that the current demographic profile is an estimation based upon a partial sampling of the establishment patron population, the current demographic profile may include a statistical certainty measure indicating how accurate the estimation is likely to be.

In one embodiment, such as that shown in FIG. 2, the display is a textual display upon a graphical monitor mounted upon the portable device. This textual display includes, for example, the statistical demographic makeup of the current population within the specified dance club with respect to age, gender, and marital status. In general, age may be specified by particular age groups, for example under 18, 18-25, 26-34, 35-44, 45-55, 56-64, and over 65. In many embodiments, the user of the cell phone may define and/or specify the particular age ranges that he or she is interested in through a configuration page of the user interface. In this example, the user is interested in 18-27 age range. In this particular example, the textual display provided to the particular user might looks as follows:
Total Patron Count: 188
18-27 year olds: 77%
Male: 31% Female: 69%
Married: 19% Single: 81%

The display example above demonstrates an embodiment that provides percentage data to the user for the demographic characteristics. Some embodiments alternatively or additionally provide absolute numerical counts. For example, the display might alternatively display the number of 18-27 year olds, the number of males, the number of females, the number of married people, and the number of unmarried people as follows:
Total Patron Count: 188
18-27 year olds: 145
Male: 58 Female: 130
Married: 36 Single: 152

In other embodiments, the user may not want to view each demographic characteristic separately but, instead, may wish to view the statistical intersection between two or more demographic characteristics. For example the user may wish to specifically view the percentage and/or number of 18-27 year old women who are single that are currently present within the particular dance club. This requires that the intersection of three different demographic characteristics be assessed by the DP server 100 and the results communicated to the client cell phone. To make such a request, the user needs to identify his demographic interests as cumulative rather than separate when interacting with the user interface of the cell phone. In one example, the user specifies that he or she wishes to find the number patrons who meet all three of the following criteria: 18-17 year old age group, female, and single.

The client DP circuitry supported by the cell phone sends a message to the DP server 100 in response to the user input, the message indicating the particular dance club that the user desired current demographic profile for as well as indicating the three specified demographic characteristics that profile information is desired for and indicating that the user desires a demographic profile of patrons who meet all three of the characteristics. Upon receiving the message from the cell phone, the DP server 100 accesses the most current demographic profile for the specified establishment and specified demographic characteristics and identifies the number and/or percentage of patrons who meet all three of the specified characteristics. The DP server 100 then communicates this information back to the requesting cell phone as well as communicating the total number of patrons currently within the given establishment. Upon receiving this data from the DP server 100, the client DP circuitry running upon the cell phone displays a representation of this data to the user. The display provided to the particular user in this example provides both the total number and the percentage (within parenthesis). The example display looks as follows:
Total Patron Count: 188
Single, Female, and 18-25 years old: 72 (38%)

Thus, a computer moderated service has been described above that facilitates the demographic profiling of particular physical establishments by compiling the demographic statistics of users who are currently located at or within each such establishment. The computer moderated service described above, also enables users to selectively access the current demographic profile of particular physical establishments according to particular demographic characteristics by accessing a server over a network and identifying the establishment(s) they desire to access current demographic profile for and by optionally specifying the particular demographic characteristics (independently or combined) that they desire current demographic profile for. The users may access information representing the current demographic profile as percentages, numerical totals, and/or other common statistical representations. The users may enter their preferences in terms of how the statistical information is accessed from the DP server 100 and/or displayed upon their user device by using a setup user interface upon their user device or another user device.

In some embodiments, users use a web browser (running on a user device) to register online for the managed demographic tracking service that is provided by a system operator who administers the system, manages information access, manages the DP server 100, operates the server DP circuitry, maintains the personal profile database, and/or coordinates information exchange with location-based establishments. In particular, the system operator runs at least one DP server 100 that receives information about users who are currently patronizing a plurality of establishments and compiles demographic statistical information for each of the plurality of establishments. In some embodiments that are designed for efficient communications, the DP server 100 receives a unique ID for each user who is currently patronizing each of a plurality of establishments along with a unique ID that identifies which establishment each user is patronizing. The DP server 100 also maintains and/or has access to a personal profile database which contains personal demographic characteristics about each user indexed by the unique ID. In this way, the DP server 100 can access demographic characteristics about each user from the DP server 100 even if only a small amount of information is communicated with respect to each user, the small amount of information including at least the unique ID for that user. In this way, the actual demographic characteristics about each user need not be communicated to the DP server 100 from a remote computing device each time a user enters an establishment.

In many embodiments, personal profile information of each user is supplied by (or derived from) entries provided by each user during the registration process and/or during subsequent update interactions with the DP server 100. The information may include, but is not limited to the user's age, birthday, gender, highest level of schooling, marital status, political affiliations, school affiliations, team affiliations, club affiliations, organizational affiliations, hobbies, interests, profession, job title and/or hierarchy level within an organization, sexual orientation, annual income, sporting team preferences, status as a tourist or resident within the current geographic region, relationship status (i.e. whether in a relationship or looking for a relationship), musical preferences, IQ, entertainment preferences, food preferences, and/or other similar personal characteristics. An exemplary registration process that may be implemented in conjunction with the methods and systems described herein is disclosed in U.S. Patent Application Publication No. 2005/0177614, which is hereby incorporated by reference.

In some embodiments, the DP server 100 maintains data about each of the users that reflect their visiting behavior with respect to particular location-based establishments. Visiting behavior data includes, for example, an indication of which location-based establishments have been visited by a particular user (indexed with respect to that users unique ID) and the frequency and/or number of times the user has visited each location-based establishments. In addition, the visiting behavior data may include the days-of-the-week and/or times-of-day that a particular user visited each location-based establishment. In some embodiments, this data is used by the DP server 100 in whole or in part to predict demographic makeup of the population of patrons that will visit a particular site at some time in the future. For example by analyzing the demographic makeup of individuals who have visited a particular location-based establishments between 8:00 PM and 10:00 PM on Thursday nights during the past 12 weeks, the DP server 100 may be able to make an accurate predication of the demographic makeup of individuals who will likely be patronizing that location next Thursday night a 9:15 PM. Using this predictive feature of the DP server 100, a user can access not just current demographic profile for a location-based establishment from the DP server 100 by communicating an inquiry, a user can also access future predictions for the demographic profile of the patron population that is likely to be present at an establishment at a particular time in the future.

Whether a user can gain access to the DP server 100 and request the current demographic profile for particular establishments depends, in some embodiments, upon that user being a registered user of the DP service. In some embodiments, being a registered user of the DP service requires a user to permit the system to track his or her patronage of location-based establishments. In this way, users gain access to current demographic profiles of establishments in exchange for providing the server access to information about that user's personal patronage of establishments. In other words, in order to gain demographic information about the current patrons to an establishment a user must, in some embodiments, allow the DP server 100 to track his or her patronage behavior. The DP server 100 may employ any one or a combination of methods to track the patronage behavior of users. Some of such methods are described in the paragraphs below.

According to numerous embodiments, the DP server 100 is adapted to collect real-time personal profile information about each individual who is currently residing within a particular establishment. A number of methods and systems may be employed to collect such information (i.e., attendance information) and transmit it to the DP server 100, these methods and systems may be used alone or in combination in various embodiments of the present invention. At the center of these methods and systems are means by which the DP server 100 is informed about the demographic characteristics of individuals who enter and/or who are present within an establishment. Such methods and systems generally fall into two classes described herein as “user ID transmission embodiments” and “user demographic transmission embodiments”.

In user ID transmission embodiments, each user is provided with a unique user identifier (i.e., a user ID) that is communicated from a remote computing device to the DP server 100 when a user enters and/or is located within an establishment. In addition, each establishment is assigned a unique identifier (referred to herein as an establishment ID) that may also be communicated to the DP server 100 to identify which establishment a particular user is patronizing. In addition, the DP server 100 maintains or has rapid access to a personal profile database such as that described above. In addition, the DP server 100 maintains or has access to an establishment database that includes information about the location-based establishments, including, for example, locative information such as address information and/or GPS coordinates or boundaries. The establishment database may also include descriptive information, service information, current demographic profile of the patron population and/or historical demographic profile of the patron population.

In user ID transmission embodiments, the user ID for each user that enters and/or is present within an establishment at particular time intervals is communicated to the DP server 100. The user ID is communicated in a message (i.e., an attendance message) that also includes an establishment ID to correlate a given user with an establishment he or she is currently patronizing. In some embodiments, a plurality of user ID values are sent in a single communication attendance message along with a single establishment ID thereby correlating a plurality of users with a particular establishment that they are then currently patronizing. Using the received user ID and establishment ID values, the DP server 100 then accesses demographic characteristics for each of the persons represented by the communicated user ID values by accessing the personal profile database using each received user ID to index the proper demographic characteristics for each user. Because each user ID is associated with a particular establishment, the demographic characteristics of the patrons to a particular establishment may be accessed and analyzed for that particular establishment. For example, if user ID values for 20 users were communicated to the DP server 100, all associated with a particular establishment ID, the demographic characteristics of each of those 20 users are accessed by the DP server 100 from the personal profile database in order to compute a current demographic profile for that particular establishment.

To facilitate this process, some embodiments maintain an establishment user list in memory accessible by the DP server 100. The establishment user list is a list of all of the received user ID values for all users who are currently determined to be patronizing a particular establishment as indexed by that establishment's unique establishment ID. Thus, when a new user ID is received as correlated with a particular establishment ID, that user ID is added to the establishment user list for that establishment. When the DP server 100 computes the current demographic profile of a particular establishment, the server DP circuitry accesses the current establishment user list for that establishment, identifies each user ID in that list, and for each user ID in the list accesses one or more demographic characteristics stored in the personal profile database indexed for that user ID. These demographic characteristics are then tallied across the set of users in the establishment user list for that establishment and a statistical analysis is performed yielding demographic profile results with respect to one or more personal demographic characteristics.

In user demographic transmission embodiments, user demographic data is stored locally on a machine maintained and used by the user. This data is transmitted to the DP server 100 each time the user enters and/or is located within an establishment. For example, the user may have a mobile computing device on his or her person, that device storing the personal demographic characteristic data for that user and communicating that data to the DP server 100 each time that user enters an establishment and/or at particular time intervals during the time the user is located within the establishment. This data is generally received by the DP server 100 along with identifying information that indicates which establishment the user is currently patronizing. As described above, the DP server 100 maintains an establishment database that includes locative information about the location-based establishments, including for example locative information such as address information and/or GPS coordinates or boundaries. The establishment database may also include descriptive information, service information, current demographic profile of the patron population and/or historical demographic profile of the patron population. In such embodiments, the establishment database is also used to store the current demographic characteristics of users who are then currently patronizing the establishment. Thus, when the DP server 100 computes the current demographic profile of a particular establishment, the server DP circuitry accesses the current establishment database and indexes the demographic information stored for each user currently patronizing that establishment for one or more demographic characteristics. This demographic information is tallied for that establishment and a statistical analysis is performed yielding demographic profile results with respect to one or more personal demographic characteristics.

For both types of embodiments described herein (i.e., the user ID transmission and user demographic transmission embodiments), information about individuals who enter establishments and/or who currently reside within establishments at given time intervals needs to be communicated to the DP server 100. Numerous exemplary embodiments described below enable such communication of such information (i.e., an individual's information). While the embodiments are described below with respect to user ID transmission-type of embodiments, in which an individual's information is the individual's user ID, it will be appreciated that similar instantiations can be employed to support user demographic transmission-type embodiments, in which an individual's information is the individual's demographic characteristic(s).

In one embodiment, an individual's information may be stored within an information object such as a personal ID card that is carried by the user. The user may swipe the personal ID card through a card reader upon entering and exiting an establishment. In one embodiment, a designated “entry” card reader may be positioned at one or more entry locations in the establishment by which only entering users may pass. Accordingly, the personal ID card can be thought of as being “operably proximate” to an establishment when it can be swiped through an entry card reader. Similarly, a designated “exit” card reader may be positioned at one or more exit location in the establishment by which only exiting users may pass. Accordingly, the personal ID card can be thought of as being “operably proximate” to an establishment when it can be swiped through an exit card reader. In many embodiments, the entry process of the establishment requires that an entering user pass by the card reader and scan his or her card to gain access to the establishment. Similarly, in many embodiments the exit process of the establishment requires that an exiting user pass by a designated “exit” card reader and swipe his or her card upon exiting.

In one embodiment, the personal ID card possessed by a user contains an encoded representation of that user's unique user ID. Each card reader is connected to computer processor local to the establishment (i.e., an establishment computer 109 such as that exemplarily described with respect to FIG. 1). The establishment computer 109 may comprise a single computer or a plurality of computers local to the location-based establishment. The establishment computer 109 is in communicative connection to the DP server 100 through the communication network 115. The establishment computer 109 receives user IDs from one or more card readers within the establishment after the user's personal ID card has been swiped through a card reader and communicates the user IDs to the DP server 100 along with identification information indicating for which establishment the user ID value is associated. The establishment computer 109 may, for example, send a message to the DP server 100 including the user IDs of users who have just entered the establishment and swiped their card upon entering, the user ID value being sent along with an establishment ID indicating which establishment that user has just entered. In some embodiments, the message may also include an attendance (i.e., entry) indicator value or flag that indicates that the user is now present within the establishment and, optionally, that the user ID was collected upon that user's entering the establishment. The message may also include an entry time-stamp indicating the time at which the user entered the establishment. In this way, the DP server 100 receives a message from the establishment computer 109 specifying the user ID of a particular user, the establishment ID of a particular establishment, a particular entry time, and the fact that the user has entered the establishment. Using this information, the DP server 100 can update stored data to reflect the fact that this particular user is now present within this particular establishment. In some embodiments, the DP server 100 updates the stored data by modifying the establishment user list for the identified establishment and adding the user ID for the particular user to that list.

Similarly, when the user leaves the establishment, he or she again scans his card through an exit card reader. The establishment computer 109 is operative to receive user ID values from the exit card reader and communicate user ID values to the DP server 100 along with identification information indicating for which establishment the user ID value is associated. The establishment computer 109, for example, may send a message to the DP server 100 including the user ID of users who have just exited the establishment and swiped their card upon exiting, the user ID value being sent along with an establishment ID indicating which establishment that user has just exited. In some embodiments, the message may also include an attendance (i.e., exit) indicator value or flag that indicates that the user has exited the establishment and, optionally, that the user ID was collected upon that user's exiting the establishment. The message may also include an exit time-stamp indicating the time at which the user exited the establishment. In this way, the DP server 100 receives a message from the establishment computer 109 specifying the ID of a particular user, the ID of a particular establishment, a particular exit time, and the fact that the user has exited the establishment. Using this information, the DP server 100 can update stored data to reflect the fact that this particular user is no longer present within this particular establishment. In some embodiments, the DP server 100 updates the stored data by modifying the establishment user list for the identified establishment and removing the user ID for the particular user to that list.

In one embodiment, an individual's information may be stored within an information object such as a card or a mobile computing device (e.g., a PDA, cell phone, wrist watch, or other similar device kept on the person of each user) that is equipped with an RFID tag that is adapted to be carried by the user or that is otherwise on the user's person. An RFID tag is a radio frequency enabled device including digital memory that may be accessed by an RFID scanner when the tag is brought within a certain proximity of such a scanner. Such tags are convenient because they operate at a distance and allow information access without needing to swipe a card. In some embodiments, RFID scanners may be positioned within the entries and exits to a location-based establishment such that users passing through an entrance are automatically scanned by an entry scanner and users passing through an exit are automatically scanned by an exit scanner. In some embodiments, the same scanner is used for entry and exit and additional sensors are used to determine the direction of motion of the user. In the example used herein, it is assumed separate scanners are used for entry and exit areas. For example, an “entry” RFID scanner may be positioned at one or more entry locations in the establishment by which only entering users may pass. Accordingly, the information object can be thought of as being “operably proximate” to an establishment when it can be scanned by an entry RFID scanner. Similarly, a designated “exit” RFID scanner may be positioned at one or more exit location in the establishment by which only exiting users may pass. Accordingly, the information object can be thought of as being “operably proximate” to an establishment when it can be scanned by an exit RFID scanner. In many embodiments, the entry process of the establishment requires that an entering user pass by the entry RFID scanner to gain access to the establishment. Similarly, in many embodiments the exit process of the establishment requires that an exiting user pass by a designated “exit” RFID scanner upon exiting.

In one embodiment, the RFID tag (in a card or device) on the person of a user contains an encoded representation of that user's unique user ID. Each RFID scanner is connected to an establishment computer 109 which is in communicative connection to the DP server 100 through the communication network. The establishment computer 109 is operative to receive a user ID from one or more RFID scanners within the establishment and communicate the user ID to the DP server 100 along with identification information indicating for which establishment the user ID value is associated. The establishment computer 109, for example, may send a message to the DP server 100 including the user ID of users who have just entered the establishment, the user ID value being sent along with an establishment ID indicating which establishment that user has just entered. In some embodiments, the message may also include an attendance (i.e., entry) indicator value or flag that indicates that the user is now present within the establishment and, optionally, that the user ID was collected upon that user's entering the establishment. The message may also include an entry time-stamp indicating the time at which the user entered the establishment. In this way, the DP server 100 receives a message from the establishment computer 109 specifying the ID of a particular user, the ID of a particular establishment, a particular entry time, and the fact that the user has entered the establishment. Using this information, the DP server 100 can update stored data to reflect the fact that this particular user is now present at or within this particular establishment. In some embodiments, this is enacted by the DP server 100 performs this update function by modifying the establishment user list for the identified establishment and adding the user ID for the particular user to that list.

Similarly, when the user leaves the establishment, he or she again is scanned by an RFID scanner. The establishment computer 109 receives user IDs from the exit scanner process and communicates the user IDs to the DP server 100 along with identification information indicating for which establishment the user ID is associated. The establishment computer 109, for example, sends a message to the DP server 100 including the user ID of users who have just exited the establishment, the user ID value being sent along with an establishment ID indicating which establishment that user has just exited. In some embodiments, the message may also include an attendance (i.e., exit) indicator value or flag that indicates that the user has exited the establishment and, optionally, that the user ID was collected upon that user's exiting the establishment. The message may also include an exit time-stamp indicating the time at which the user exited the establishment. In this way, the DP server 100 receives a message from the establishment computer 109 specifying the user ID of a particular user, the establishment ID of a particular establishment, a particular exit time, and the fact that the user has exited the establishment. Using this information the DP server 100 can update stored data to reflect the fact that this particular user is no longer present within this particular establishment. In some embodiments the DP server 100 updates the stored data by modifying the establishment user list for the identified establishment and removing the user ID for the particular user to that list.

In some embodiments, the determination of whether or not a particular user is at or within a particular establishment is performed based upon spatially locative information regarding the current personal location of a given user. This is generally achieved using a mobile computing device local to each user that is enabled within a locative tracking capability. A common technology for supporting such locative tracking is a GPS transceiver local to a computing device upon the person of each user. The GPS transceiver determines the current geographic location of the user by interfacing with a global positioning satellite system. Thus, in one embodiment, a mobile computing device local to the person of a plurality of users may include (but is not limited to) a cell phone, personal digital assistant (PDA), portable media player, or processor enabled wristwatch. Each mobile computing device includes a wireless connection to a communication network such as the Internet, each mobile computing device operative to communicate with the DP server 100 over the network.

In some such embodiments, each mobile computing device local to a particular user communicates its location and the unique user ID of its user to the DP server 100 at regular intervals. The DP server 100 maintains a database that indicates the spatial location and/or spatial boundaries of a plurality of location-based establishments. This data may be maintained in various database formats. In some embodiments, the data is maintained as part of the establishment database mentioned previously. For example, the location of a particular establishment may be represented within the establishment database as a set of GPS coordinates that define the boundary of that establishment.

In such embodiments, the DP server 100 determines, from the locative information received from each user, whether that user is at or within a particular establishment by comparing the current location of that user (as represented by the most recent locative information received for that user) with the location information for each of a plurality of establishments. For example, when the DP server 100 determines that the location of a particular user falls within the boundary coordinates of a particular establishment, that user is determined to be within that establishment. The DP server 100 may then update the stored data to reflect the fact that this particular user is now present at or within this particular establishment. In some embodiments, the DP server 100 updates the stored data by modifying the establishment user list for the identified establishment and adding the user ID for the particular user to that list. Similarly, when the DP server 100 determines from subsequent locative information received from a particular user that that user's location no longer falls within the boundary coordinates of a particular establishment, that user is determined to have left that establishment. The DP server 100 then updates stored data to reflect the fact that this particular user is no longer present within this particular establishment. In some embodiments, the DP server 100 updates the stored data by modifying the establishment user list for the identified establishment and removing the user ID for the particular user to that list. Accordingly, a mobile computing device as described above can be thought of as always being “operably proximate” to an establishment when its position relative to the location of an establishment can be determined.

In some embodiments, the indication that a particular user is at or within a particular establishment is sent manually by a user through interactions with a mobile computing device on his or her person. In this sense, the mobile computing device may be treated as an information object. This may be generally achieved using a messaging function in which the user sends an encoded message such as a text message from a mobile computing device to the DPS server, the message indicating that the user has either entered or exited a particular location-based establishment. The message typically includes a representation of the user's unique user ID, a representation of the location-based establishment's unique establishment ID, and a flag or other indicator indicating if the referenced user has entered, exited, or is currently at or within the referenced establishment. In some embodiments, the message includes a time stamp as well. In some embodiments, the user selects a particular establishment from a list of available establishments through a user interface provided upon the mobile computing device. Upon selecting the establishment, the user is enabled to indicate if he or she is entering, exiting, or remaining within the establishment through the user interface. Upon a change of state with respect to the particular establishment, the portable computer supporting the client DP circuitry sends a message containing the representative state information to the DP server 100. Accordingly, a mobile computing device as described above can be thought of as always being “operably proximate” to an establishment when its position relative to the location of an establishment can be determined by the user.

In such embodiments, the DP server 100 is adapted to determine from the messages received from the mobile computing devices of a plurality of users if each of those users is currently at or within particular location-based establishments. The DP server 100 is further adapted to update the stored data to reflect which particular users are present at which particular establishments. In some embodiments, the DP server 100 updates the stored information by modifying the establishment user list for a plurality of establishments, adding and/or removing user IDs as appropriate.

In some embodiments, messages sent from the mobile computing devices to the DP server 100 are triggered automatically based upon signals received by the mobile computing device from transmitters within or near a particular location-based establishment. For example, upon approaching, entering, or residing within a particular establishment, a mobile computing device (e.g., an appropriately enabled cell phone computing device) on the person of a user may receive a signal (e.g., a radio signal) indicating that the device is now within a particular establishment. The signal may include the encoded establishment ID for that establishment. Upon receiving such a signal, the mobile computing device may be adapted to automatically send a message to the DP server 100 over a wireless communication link, the messaging indicating to the DP server 100 the user ID of the user of the mobile computing device, the establishment ID of the establishment in question, and optionally a time stamp.

In some embodiments exemplarily described above, a demographic profile of a patron population may be tracked while keeping the unique and specific identify of each individual within the patron population strictly anonymous. This allows users to be more comfortable about having their personal qualities such as age, gender, political affiliation, and hobbies, to be processed by the DP server 100 and used in the computation of demographic profile statistical information. To achieve such anonymity, some embodiments track users with respect to a user ID that is not correlated with the user's name, social security number, address, phone number, or any other information that would specifically and uniquely identify the individual. For example, in some embodiments, each user who registers with the service is assigned a unique user ID and is asked to provide generic demographic information about himself or herself such as age, gender, political party affiliation, sports team preferences, hobbies, etc. The unique user ID is used to index such non-unique personal characteristics such as age, gender, political party affiliation, sports team preferences, and hobbies, but is not linked that that user's name, address, phone number, social security number, or other personal identifier. In this way, the DP server 100 can store and process informative personal qualities about individuals without specifically knowing who those individuals are.

While the invention herein disclosed has been described by means of specific embodiments, examples and applications thereof, numerous modifications and variations could be made thereto by those skilled in the art without departing from the scope of the invention set forth in the claims.

What is claimed is:

1. A location-based demographic profiling method, comprising:
receiving, over a network, a profile request from a user device, the profile request identifying at least one establishment from a plurality of pre-identified establishments;
upon receiving the profile request, determining a current demographic profile of each establishment identified in the profile request, wherein each current demographic profile is a statistical representation of the number of individuals residing within an identified establishment who possess at least one identified demographic characteristic; and
transmitting demographic profile data to the user device, the demographic profile data being adapted to cause the user device to present each determined demographic profile to be presented to the user.

2. The location-based demographic profiling method of claim 1, wherein
the profile request identifies at least one demographic characteristic of a plurality of predetermined demographic characteristics; and
determining the current demographic profile based upon the at least one demographic characteristic identified in the profile request, wherein demographic characteristics represented within the current demographic profile correspond to the at least one demographic characteristic identified within the profile request.

3. The location-based demographic profiling method of claim 2, wherein at least one demographic characteristic is selected from the group consisting of age, gender, highest level of schooling, marital status, political party affiliations, school affiliations, team affiliations, club affiliations, organizational affiliations, hobbies, interests, profession, job title and/or hierarchy level within an organization, sexual orientation, annual income, sporting team preferences, status as a tourist or resident of the current geographic region, relationship status (i.e. whether in a relationship or looking for a relationship), musical preferences, IQ, entertainment preferences, and food preferences.

4. The location-based demographic profiling method of claim 1, further comprising:
receiving an individual's information from an information object that is operably proximate to an establishment and is associated with the individual; and
generating an attendance message, the attendance message comprising an establishment identifier, the received individual's information, and an attendance indicator, the establishment identifier uniquely identifying the establishment the information object is operably to, and the attendance indicator indicating whether the individual has entered into or exited from the establishment, wherein
determining the current demographic profile comprises determining the current demographic profile based upon the establishment identifier and the individual's information comprised within an attendance message.

5. The location-based demographic profiling method of claim 4, wherein the individual's information comprises a user identifier uniquely identifying the individual.

6. The location-based demographic profiling method of claim 4, wherein the individual's information comprises at least one demographic characteristic of the individual.

7. The location-based demographic profiling method of claim 4, wherein the information object is a personal identification card, an RFID card, or a mobile computing device.

8. The location-based demographic profiling method of claim 1, wherein the demographic profile data is adapted to cause the user device to present the determined demographic profile to the user in at least one of a graphical and an aural form.

9. The location-based demographic profiling method of claim 1, wherein the demographic profile data is adapted to cause the user device to present the determined demographic profile including a representation of at least one separate demographic characteristic.

10. The location-based demographic profiling method of claim 9, wherein the at least one separate demographic characteristic is a gender characteristic.

11. The location-based demographic profiling method of claim 1, wherein the demographic profile data is adapted to cause the user device to present the determined demographic profile including a representation of at least one statistical intersection of a plurality of demographic characteristics.

12. The location-based demographic profiling method of claim 11, wherein the at least one statistical intersection of a plurality of demographic characteristics is a statistical intersection of a gender characteristic and an age characteristic.

13. The location-based demographic profiling method of claim 1, wherein the demographic profile data is adapted to cause the user device to display the determined demographic profile to the user as at least one of a numerical total of individuals who possess each demographic characteristic represented within the demographic profile and are currently residing within the establishment identified in the profile request and as a percentage of individuals who possess each demographic characteristic each demographic characteristic represented within the demographic profile and are currently residing within the establishment identified in the profile request.

14. A location-based demographic profiling system, comprising:
a server containing server demographic profiling (DP) circuitry adapted to:
receive, over a network, a profile request from a user device, the profile request identifying at least one establishment from a plurality of pre-identified establishments;
determine a current demographic profile of each establishment identified in the profile request upon receiving the profile request, wherein each current demographic profile is a statistical representation of the number of individuals residing within an identified establishment who possess at least one identified demographic characteristic; and
transmit demographic profile data to the user device, the demographic profile data being adapted to cause the user device to present each determined demographic profile to be presented to the user.

15. The location-based demographic profiling system of claim 14, wherein
the profile request identifies at least one demographic characteristic of a plurality of predetermined demographic characteristics; and
the server DP circuitry is adapted to determine the current demographic profile based upon the at least one demographic characteristic identified in the profile request, wherein demographic characteristics represented within the current demographic profile correspond to the at least one demographic characteristic identified within the profile request.

16. The location-based demographic profiling system of claim 15, wherein at least one demographic characteristic is selected from the group consisting of age, gender, highest level of schooling, marital status, political party affiliations, school affiliations, team affiliations, club affiliations, organizational affiliations, hobbies, interests, profession, job title and/or hierarchy level within an organization, sexual orientation, annual income, sporting team preferences, status as a tourist or resident of the current geographic region, relationship status (i.e. whether in a relationship or looking for a relationship), musical preferences, IQ, entertainment preferences, and food preferences.

17. The location-based demographic profiling system of claim 14, further comprising:
an establishment computer containing client DP circuitry adapted to:
receive an individual's information from an information object that is operably proximate to an establishment and is associated with the individual; and
generate an attendance message, the attendance message comprising an establishment identifier, the received individual's information, and an attendance indicator, the establishment identifier uniquely identifying the establishment the information object is operably to, and the attendance indicator indicating whether the individual has entered into or exited from the establishment, wherein
the server DP circuitry is further adapted to determine the current demographic profile based upon the establishment identifier and the individual's information comprised within an attendance message.

18. The location-based demographic profiling system of claim 17, wherein the individual's information comprises a user identifier uniquely identifying the individual.

19. The location-based demographic profiling system of claim 17, wherein the individual's information comprises at least one demographic characteristic of the individual.

20. The location-based demographic profiling system of claim 17, wherein the information object is a personal identification card, an RFID card, or a mobile computing device.

21. The location-based demographic profiling system of claim 14, wherein the demographic profile data is adapted to cause the user device to present the determined demographic profile to the user in at least one of a graphical and an aural form.

22. The location-based demographic profiling system of claim 14, wherein the demographic profile data is adapted to cause the user device to present the determined demographic profile including a representation of at least one separate demographic characteristic.

23. The location-based demographic profiling system of claim 22, wherein the at least one separate demographic characteristic is a gender characteristic.

24. The location-based demographic profiling system of claim 14, wherein the demographic profile data is adapted to cause the user device to present the determined demographic profile including a representation of at least one statistical intersection of a plurality of demographic characteristics.

25. The location-based demographic profiling system of claim 24, wherein the at least one statistical intersection of a plurality of demographic characteristics is a statistical intersection of a gender characteristic and an age characteristic.

26. The location-based demographic profiling system of claim 14, wherein the demographic profile data is adapted to cause the user device to display the determined demographic profile to the user as at least one of a numerical total of individuals who possess each demographic characteristic represented within the demographic profile and are currently residing within the establishment identified in the profile request and as a percentage of individuals who possess each demographic characteristic each demographic characteristic represented within the demographic profile and are currently residing within the establishment identified in the profile request.

27. A location-based demographic profiling method, comprising:
providing a DP Server operative to maintain demographic profile information for each of a plurality of physical establishments, the demographic profile information representing the number of individuals known to be currently residing within the establishment who possess each of a plurality of different demographic characteristics;
enabling profile requests to be made to the DP Server by each of a plurality of distant users of separate computing devices, each of the profile requests being communicated from each separate computing device to the DP server and indicating at least one physical establishment to be profiled;
transmitting demographic profile information to each of the separate computing devices in response to each of the profile requests, the demographic profile information including statistical data indicating the number of individuals possessing each of a plurality of different demographic characteristics who are known to be currently residing within the at least one physical establishment identified by the profile request received from that particular separate computing device; and
enabling the display of the demographic profile information to the user of each of the separate computing devices, the display being at least one of a graphical representation of the demographic profile information that was transmitted to that separate computing device in response to a profile request received from that separate computing device and an aural representation of the demographic profile information that was transmitted to that separate computing device in response to a profile request received from that separate computing device.

28. The location based demographic profiling method of claim 27, further comprising repeatedly receiving upon the DP Server, update information for each of a plurality of physical establishments, the update information representing at least one of an identification of individuals known to have recently entered or existed the establishment and a demographic profile of individuals known to have recently entered or existed the establishment.

29. The location based demographic profiling method of claim 28, further comprising updating the demographic profile information maintained upon the DP Server for each of a plurality of establishments based upon the update information received for each establishment, the updating comprising adjusting the demographic profile information representing the number of individuals known to be currently residing within each establishment who possess each of a plurality of different demographic characteristics.
